(19) United States
(12) Patent Application Publication
(10) Pub. No.: US 2007/0154052 A1
(43) Pub. Date: Jul. 5, 2007

(54) Noise cancelling cable assembly

(75) Inventor: Christopher Carl Gantz, Northbrook, IL (US)

Correspondence Address: DAVID I. ROCHE;BAKER & MCKENZIE LLP, 130 EAST RANDOLPH DRIVE, CHICAGO, IL, 60601, US

(73) Assignee: SYNC1, Northbook, IL (US)

(21) Appl. No.: 11/649,990

(22) Filed: Jan. 4, 2007

Related U.S. Application Data
(60) Provisional application No. 60/756,297, filed on Jan. 4, 2006.

(51) Int. Cl. H04R 25/00

(52) U.S. Cl. 381/384

(57) ABSTRACT

The inventions disclosed and claimed herein relate to a family of cable assemblies which are adapted for use with personal headphones. Various configurations of the assemblies are disclosed herein, each of which provide some combination of many diverse features, including: (1) capability for converting a passive headphone into an active noise reducing headphone; (2) capability for converting a personal stereo headphone for use with a mobile phone; (3) capability for integrating two audio sources for use with a single set of headphones; and (4) capability for wireless communications between the cable assembly and any one or more of the audio sources and headphones.

### BACKGROUND OF THE INVENTIONS

The instant application is based on Provisional Application No. 60/756,297 filed on Jan. 4, 2006.

The inventions described herein relate to cable assemblies for personal listening and/or communicating devices. In particular, this invention relates to a family of circuited cable assemblies which allow a listener to easily convert an existing personal stereo headphone for alternative uses, such as into an active noise reducing headphone, into a cellular/mobile phone headphone, and/or into a headphone with capabilities for toggling between alternative audio sources.

The use of noise reducing (or canceling) headphones has increased dramatically in recent years. Noise reducing headphones reduce unwanted noise, typically through the use of active noise canceling circuitry, at least one microphone (and usually two microphones) and a driver. The microphones capture the unwanted external noise and transfer a corresponding signal to the circuitry. The circuitry processes the external noise signal to create a noise canceling signal which is transferred to the driver for delivery to the listener. See, for example, U.S. Pat. No. 5,182,774, which is incorporated herein by reference.

The use of active noise reducing headphones is typically recognized as preferred over the use of passive headphones, especially in high noise situations, such as on commercial aircraft. While noise canceling headphones provide many benefits, there are some drawbacks. First, noise reducing headphones are typically very expensive. For example, the Bose® QuietComfort® headphones retail for $299. See www.bose.com. Second, noise reducing headphones incorporate the noise reducing circuitry and microphones into the headphones. Because most portable music players are sold as a package with passive headphones (or ear buds), a purchaser must abandon the previously purchased passive headphone in order to obtain noise canceling capabilities. Therefore, there is a need for a device which will provide a cost effective method for converting passive headphones into noise canceling headphones.

In recent years, mobile phones and portable electronic music players have also become very popular. There is a recent trend to minimize the size of such devices to improve portability. Manufacturers have been so successful in minimizing the size of such devices that many people routinely carry around both a mobile phone and a music player at the same time. However, there is one problem with such devices that manufacturers have thus far failed to solve; mobile phones and music players typically utilize different types of headphones. Mobile phones typically incorporate a 2.5 mm jack for use with an assembly having a single ear bud and a microphone while music players typically incorporate a 3.5 mm jack for use with ear buds or headphones. Accordingly, a user must typically carry around two sets of ear buds or headphones in order to use both devices (if hands-free communication is desired). Therefore, there is a need for a device which will provide a cost effective method for converting existing personal headphones into a mobile phone headphone to improve portability of communication and music playing devices. Additionally, there is a need for a device which integrates a mobile phone and a music playing device with a single personal headphone to allow a user to easily toggle between the two devices.

### SUMMARY OF THE INVENTIONS

The present inventions relate to a family of circuited cable assemblies which solves the problems of the prior art. Generally, the cable assemblies of the present invention are adapted to enhance a passive stereo headphone, such as Apple Ipod buds, Sony Walkman headphones, Koss Stereophones, etc. The cable assemblies of the present invention are intended to be modular; i.e., a listener need only purchase one cable assembly for use with a multitude of headphones.

One such embodiment of the present invention comprises a cable assembly which converts a passive headphone into an active noise canceling headphone. The noise reducing cable assembly preferably comprises the microphones and circuitry necessary to convert the passive headphone into a noise canceling headphone, wherein the headphone acts as the driver to deliver the noise canceling signal to the listener. It is contemplated that the noise reducing cable assembly will generally comprise a pod for housing noise canceling hardware (i.e., the microphone(s) and the circuitry) and a plug-in jack for receiving the plug from the headphone. The plug-in jack may be incorporated into the pod. The noise reducing cable assembly may also include a plug for plugging into an audio source, such as a mobile phone or music player. In the event that the noise reducing cable assembly is adapted for use with a mobile phone, the assembly will also include an additional microphone for capturing the voice of the user. The communications microphone may also be incorporated into the pod. Accordingly, the noise canceling cable provides an inexpensive method for converting a passive headphone into a noise canceling headphone.

A second such embodiment comprises a cable assembly for converting a headphone for use with a mobile phone. It is contemplated that any headphone, including passive or active noise canceling headphones, can be used with the mobile phone cable assembly. The mobile phone cable assembly preferably comprises a plug for plugging into the mobile phone, a jack for receiving a plug from headphones, a microphone for capturing the voice of the user, and a switch (or button) for answering and hanging up the phone. These components are interconnected by cables and can be housed in a single pod, if so desired. For users who wish to use passive headphones, but desire the benefits of active noise cancellation, it is contemplated that the mobile phone cable assembly can include the active noise canceling components described above, i.e. the active noise canceling circuitry and microphone(s). Accordingly, the mobile phone cable assembly provides an inexpensive method for converting a passive headphone into a mobile phone headphone.

A third such embodiment comprises a cable assembly for converting a headphone for use with multiple audio sources, such as a mobile phone and a music player. The integrating cable assembly preferably comprises a plug for plugging into the first audio source, a plug for plugging into the second audio source, a jack for receiving the plug from a headphone (passive or otherwise), and a switch for allowing the user to toggle between the two audio sources. In the event that one of the audio sources is a mobile phone, the cable assembly will also comprise a microphone for capturing the voice of the user and a button for answering and hanging up the phone. Like the mobile phone assembly briefly described above, the integrating cable assembly can include noise canceling hardware for converting a passive headphone into a noise canceling headphone. Accordingly, the integrating cable assembly provides an inexpensive method for allowing a listener to selectively use two audio sources without the hassle of having to unplug the headphone from one device and plug the headphone into the other device (or having to carry two sets of headphones).

### BRIEF DESCRIPTION OF THE DRAWINGS

These and other features, aspects, objects, and advantages of the inventions described and claimed herein will be become better understood upon consideration of the following detailed description, appended claims and accompanying drawings where:

FIG. 1 is a plan view of a first embodiment of the cable assemblies of the present invention for converting a passive headphone into a noise canceling headphone;

FIG. 2 is a side view of the microphone pod of the first embodiment;

FIG. 3 is a plan view of a second embodiment of the present inventions for converting a stereo headphone for use with a mobile phone;

FIG. 4 is a plan view of a third embodiment of the present inventions for integrating two audio signals for use with a single headphone;

FIG. 5 is a plan view of a fourth embodiment of the present inventions for converting a passive headphone into a noise canceling headphone and for integrating two audio signals for use with the single headphone; and,

FIG. 6 is a plan view of a fifth embodiment of the present inventions incorporating wireless connections to convert a passive headphone into a noise canceling headphone and to integrate two audio signals for use with the single headphone.

It should be understood that the drawings are not necessarily to scale and that the embodiments are sometimes illustrated by graphic symbols, phantom lines, diagrammatic representations and fragmentary views. In certain instances, details which are not necessary for an understanding of the inventions described and claimed herein or which render other details difficult to perceive may have been omitted. It should be understood, of course, that the inventions described herein are not necessarily limited to the particular embodiments illustrated herein.

Like reference numerals will be used to refer to like or similar parts from Figure to Figure in the following description of the drawings.

### DETAILED DESCRIPTION OF THE PREFERRED EMBODIMENTS

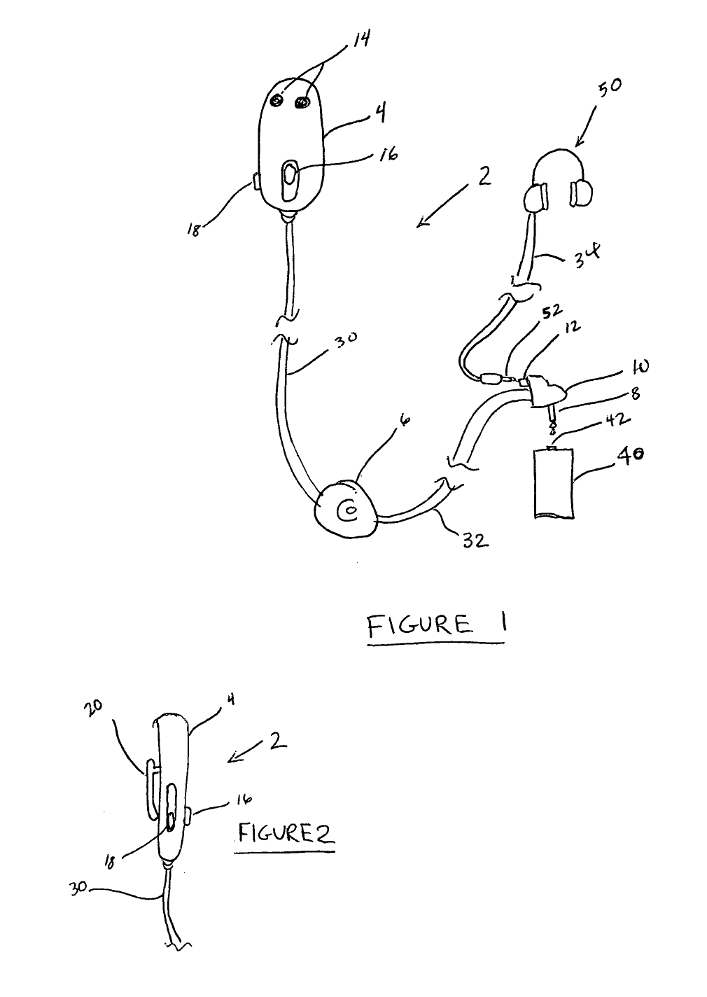

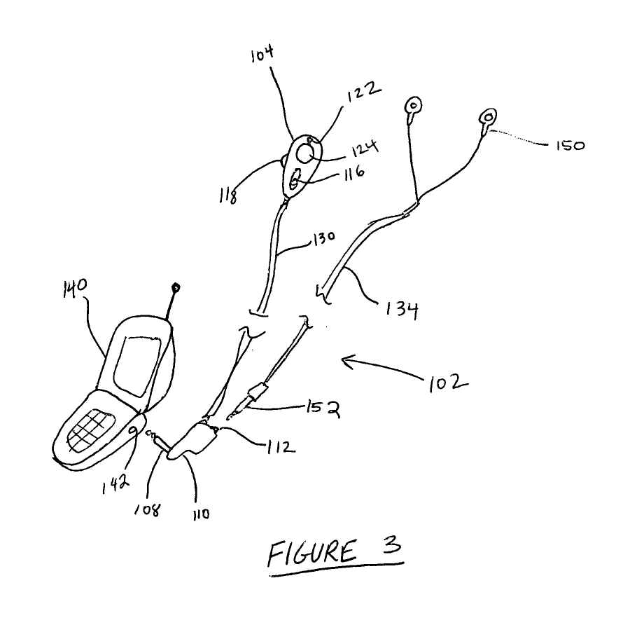

FIGS. 1 and 2 generally depict one of the preferred embodiments of the present inventions: a noise canceling cable assembly for converting a passive headphone into an active noise reduction headphone. A plan view of a noise canceling cable assembly 2 is shown in FIG. 1. The noise canceling cable assembly 2 preferably comprises a microphone pod 4, a battery pack (or circuit pod) 6, and a plug 8. The pod 4, the battery pack 6, and the plug 8 are preferably interconnected by cables 30 and 32, wherein cable 30 interconnects the pod with the battery pack 6 and cable 32 interconnects the battery pack 6 with the plug 8.

The plug 8 is adapted for plugging into a jack 42 on an audio source 40 such as a music playing device or a mobile phone. The audio source 40 includes any audio source, such as home stereos, televisions, audio jacks on airline armrests, etc. The plug 8 can be any type of plug, including a 2.5 mm plug for mobile phones or a 3.5 mm plug for music players. The body 10 of the plug preferably also includes a jack 12 for receiving a plug 52 from a headphone 50. Alternatively, the jack 12 for receiving the plug 52 can be disposed on the battery pack 6 or the pod 4. Note that the headphone 50 can be embodied as headphones (as shown) or as any other type of headphone, including ear buds.

The circuit pod (or battery pack) 6 is adapted to house the active noise cancellation circuitry (not shown) and a battery (not shown) for powering the active noise cancellation circuitry (not shown). The noise canceling assembly 2 of the present invention can, for example, incorporate the noise cancellation technology of Andrea Electronics Corp., Melville, N.Y. See U.S. Pat. No. 6,061,456 which is incorporated herein by reference. However, any of several alternative noise cancellation technologies (known or unknown at the time of filing this application), size permitting, could be incorporated into the noise canceling assembly 2 of the present invention. Although depicted as a separate housing, the battery and/or the circuitry can be incorporated into the microphone pod 4 or the body 10, if so desired. Also, as discussed above, the circuit pod 6 can include a jack for receiving the plug 52 for headphones 50.

The microphone pod 4 preferably comprises at least one microphone, an on/off switch 16 for the active noise reduction circuitry, and a volume control 18 for the audio source 40. Preferably, the microphone pod 4 comprises dual, omni-directional microphones. The microphones 14 of the microphone pod 4 serve to capture the unwanted external noise for processing by the active noise canceling circuitry. As shown in FIG. 2, the pod 4 also includes a clip 20 for attaching the pod to the listener's shirt (not shown), preferably on the lapel of the shirt. Alternatively, the pod 4 could include a strap or a band for attaching the pod 4 to a listener's arm, pants, or belt. It is contemplated that a clip 20 (or its alternatives) could be added to any of the pods for any of the embodiments of the present inventions described herein.

Incorporating the microphone(s) 14 for the noise reduction system into the pod 4 assembly is contrary to accepted wisdom. As discussed above, existing noise reducing headphones all incorporate microphones into the headphones near the listener's ears with the aim of accurately capturing the unwanted noise which is subjected to the listeners ears. Conversely, the pod 4 is intended to be disposed on a listener's shirt (or other part of the listener's body; i.e., arm, wrist, waist, etc), slightly distancing the microphone(s) 14 from the listener's ear. It is believed that any reduction in noise reduction capability due to the location of the microphone(s) 14 would be slight and would be acceptable in light of the beneficial modular capabilities of the assembly 2. Additionally, the use of noise reduction headphones is most prevalent on airplanes where the ambient noise to be cancelled (i.e. the jet engine noise) is essentially the same whether detected at ear level, at the chest level, at the wrist level, or at the waist level.

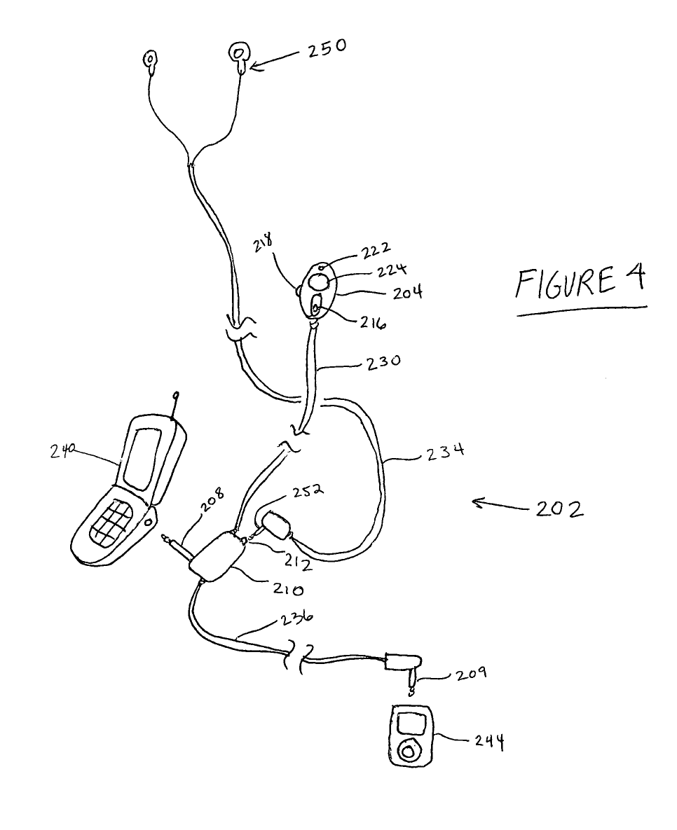

A second embodiment of the present invention, a mobile phone cable assembly 102 which converts a stereo headphone (or ear buds) 150 into a headphone for a cellular phone 140, is depicted in FIG. 3. The mobile phone cable assembly 102 preferably comprises a microphone/control pod 104 and a plug body 110, which are interconnected by cable 130. The plug body 110 preferably comprises a plug 108 for plugging into the cellular phone and a jack 112 for receiving the plug 152 of a headphone 150. The plug 108 is preferably a 2.5 mm plug but can be any other plug as necessary to be compatible with the female jack 142 on the mobile phone 140. The jack 112 is preferably a 3.5 mm Stereo jack. The microphone/control pod 104 preferably comprises a microphone 124 for capturing the voice of the user, a button 122 for answering and hanging up the phone, a switch 116 for turning the cable assembly 102 on and off, and a volume control 118 for adjusting the volume of the signal delivered to the headphone 150.

It is contemplated that the active noise reduction components of the first embodiment described above can be incorporated into the mobile phone cable assembly 102. This would likely require the addition of a battery/circuit pod (not shown) in cable 130 for processing noise captured by at least one microphone (not shown), which would be incorporated into the pod 104. If the noise reduction components were added to the assembly 102, the switch 116 would be modified to allow the user to toggle between phone mode and noise reduction mode. When in the noise reduction mode, it is contemplated that the assembly 102 could be modified to automatically interrupt the noise reduction mode to notify the user of an incoming call.

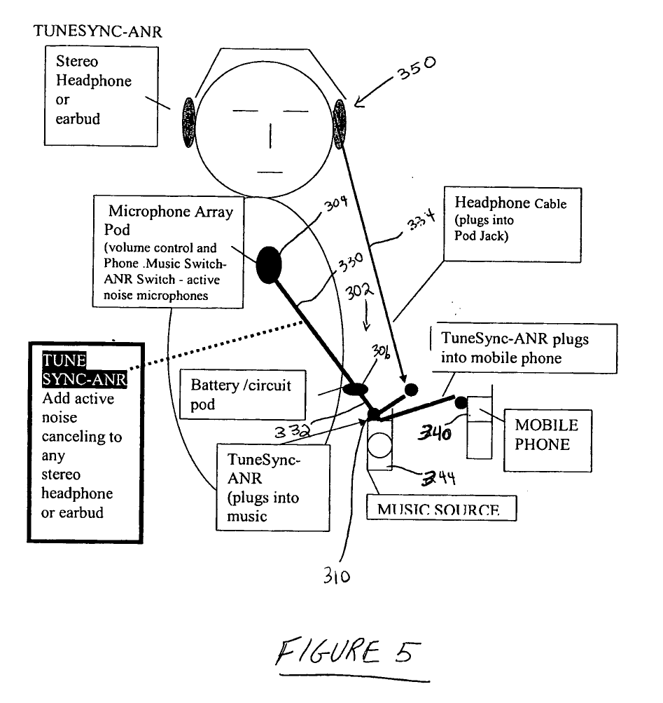

A third embodiment of the present invention, an integrating cable assembly 202 for integrating sound signals from multiple audio sources 140, 144 for listening with a single headphone 250, is depicted in FIG. 4. As depicted in FIG. 4, the cable assembly 202 is adapted to integrate two audio sources wherein the first audio source 240 is a mobile phone and the second audio source 244 is an electronic music player. However, the invention is not limited as such. Indeed, the present invention can be adapted for use with virtually any audio source and can be adapted to integrate more than two audio sources.

The integrating cable assembly 202 preferably comprises a microphone/control pod 204 and a cable junction 210. The cable junction 210 preferably comprises a jack 212 for receiving the plug 252 of the headphone 250 and two plugs 208, 209, the first plug 208 for plugging into a first audio source 240 and the second plug 209 for plugging into a second audio source 244. The first plug 208 is preferably a 2.5 mm plug to be compatible with a mobile phone 240, the second plug 209 is preferably a 3.5 mm plug to be compatible with an electronic music player 244, and the jack 212 is preferably a 3.5 mm jack to be compatible with a stereo headphone 250. However, the plugs 208, 209 and jack 212 can be modified as necessary to be compatible with any other devices. As depicted, the plug 208 and the jack 212 are integrated into a single housing while the plug 208 is attached to the housing by a cable 236. A person of ordinary skill in the art would recognize that the junction 210 could be modified to incorporate the plugs 208, 209 and the jack 212 into a single housing, or separate one or more of the components 208, 209, 212 by cables.

The microphone/control pod 204 preferably comprises a toggle switch 216 for toggling between audio sources, a volume control 218 for adjusting the volume of the audio, a button 222 for answering and hanging up phone calls, and a speaker 224 for capturing the voice of the user. The toggle switch 216 could have two or more positions, wherein the toggle switch would activate the phone mode in a first position and activate the music mode in a second position. Additionally, the toggle switch 216 could have a third position which would deactivate the cable assembly altogether (i.e., off). When the assembly 202 is in the music mode, it is contemplated that the assembly 202 could be configured to interrupt the music mode to alert the listener by sound of an incoming call.

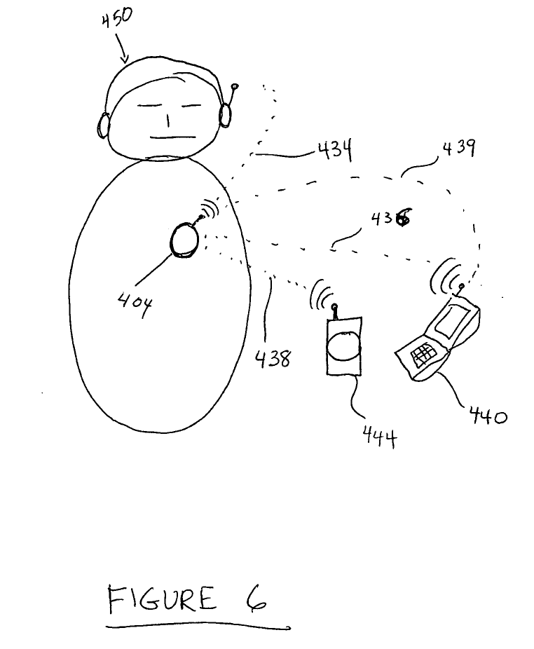

A fourth embodiment of the present invention, a noise reducing/integrating cable assembly 302, is depicted in FIG. 5. The noise reducing/integrating cable assembly 302 is adapted to not only convert a passive headphone 350 into a noise canceling headphone, but also to integrate two audio signals from two audio sources 340, 344 for use with a single headphone 350. The assembly 302 is preferably comprised of a cable junction 310 for connecting to multiple audio sources and for connecting to a passive headphone 350. As depicted, the cable junction is connected to two audio sources, a mobile phone 340 and a music player 344. Although not shown, it is contemplated that the cable junction will comprise a first plug for plugging into the mobile phone 340, a second plug for plugging into the music player 344, and a jack for receiving the plug of a headphone 350. Furthermore, the cable junction 310 can be embodied as a housing or as a “web” of cables.

The cable junction 310 is preferably interconnected with a battery/circuit pod 306 by cable 332. The battery/circuit pod 306 preferably houses the active noise reduction circuitry and a battery for powering the active noise reduction circuitry. The battery/circuit pod is preferably interconnected by cable 330 to the microphone/control pod 304. Although not depicted in FIG. 5, it is contemplated that the pod 304 includes at least one (and preferably two) microphone for capturing unwanted noise; a microphone for capturing the voice of the listener; a volume control for adjusting the volume of the audio source; a switch for toggling between phone mode and music mode; and a button for answering and hanging up a phone call.

Note that any of the cables 30, 32, 34, 130, 134, 230, 234, 236, 330, 332, 334 could be replaced by wireless connections, such as Bluetooth, as depicted in FIG. 6. Accordingly, a fifth embodiment is described herein to convert a passive, wireless headphone into a noise canceling headphone. For example, a wireless assembly 404 for reducing noise and integrating multiple audio sources is contemplated which would wirelessly receive a first input signal 436 from a first audio source 440 and a second input signal 438 from a second audio source 444. Note that it is contemplated that the wireless assembly 404 could also be configured to receive only one audio signal or additional wireless (or wired) input signals in the event that there were more than two audio sources. The depicted assembly 404 would include a toggle switch for selecting between the audio sources 440, 444 and a volume control for controlling the volume of the audio source 440, 444. Accordingly, the appropriate audio signal would be wirelessly transmitted 434 to the headphone 450.

The assembly 404 would also include active noise reduction circuitry and at least one microphone for capturing unwanted noise. Along with the audio signal, the assembly 404 would wirelessly transmit 434 a noise canceling signal to the headphone 450. To enable phone communications, the assembly 404 would also include a microphone for capturing the voice of the user and a button for answering and hanging up the phone. Signals from the microphone and button would be wirelessly transmitted 439 back to the phone 440.

Note that the above described embodiments, that include active noise reducing circuitry and are adapted for use with a mobile phone, preferably use three microphones, two for active noise reduction and one for communications. However, in the preferred embodiment, the active noise canceling circuitry is deactivated when the toggle switch is set to phone mode. Therefore, it is contemplated that a single microphone could be used for both active noise cancellation and for communications. In an alternative embodiment, the noise canceling circuitry is active when the toggle switch is set to phone mode.

Although the inventions described and claimed herein have been described in considerable detail with reference to certain preferred embodiments, one skilled in the art will appreciate that the inventions described and claimed herein can be practiced by other than the preferred embodiments, which have been presented for purposes of illustration and not of limitation. In addition, any feature described with reference to any single embodiment can by applied to any of the other embodiments. Therefore, the spirit and scope of the appended claims should not be limited to the description of the preferred embodiments contained herein.

What is claimed is:

1. A cable assembly adapted for use with a personal stereo headphone, the cable assembly comprising:
a plug for plugging into an audio source;
a jack for receiving a plug from the headphone;
a microphone pod having at least one microphone for capturing a noise and generating a noise signal, an on/off switch for the cable assembly, and a volume control for controlling the volume of the audio source; and,
an active noise reduction pod having an active noise reduction circuitry for converting said noise signal into a noise canceling signal for delivery to the headphone.

2. The cable assembly of claim 1 wherein the at least one microphone is an omni-directional microphone.

3. The cable assembly of claim 1 wherein the number of the at least one microphone is two.

4. The cable assembly of claim 3 wherein the audio source is an electronic music player.

5. The cable assembly of claim 3 wherein the audio source is a mobile phone, the cable assembly further comprises a communications microphone, and the on/off switch toggles between active noise reduction mode and phone mode.

6. The cable assembly of claim 1 wherein the audio source is a mobile phone, the on/off switch toggles between active noise reduction mode and phone mode, and the at least one microphone is also for capturing a voice when the toggle switch is in the phone mode.

7. The cable assembly of claim 5 wherein the cable assembly further comprises a switch for answering an incoming phone call.

8. The cable assembly of claim 5 wherein the cable assembly further comprises a switch for hanging up on a phone call.

9. The cable assembly of claim 3 wherein the plug for plugging into an audio source is a 3.5 mm plug.

10. The cable assembly of claim 3 wherein the plug for plugging into an audio source is a 2.5 mm plug.

11. The cable assembly of claim 3 wherein the jack for receiving the plug from the headphone source is a 3.5 mm jack.

12. The cable assembly of claim 3 wherein the microphone pod further comprises a clip for attaching to a clothing article of a person.

13. The cable assembly of claim 3 wherein the microphone pod further comprises a strap for attaching to a person.

14. A cable assembly adapted for use with a personal stereo headphone, the cable assembly comprising:
a plug for plugging into an audio source;
a jack for receiving a plug from the headphone;
at least one microphone for capturing a noise and generating a noise signal;
an on/off switch for turning the cable assembly on and off;
a volume control for controlling the volume of the audio source; and,
an active noise reduction circuitry for converting said noise signal into a noise canceling signal for delivery to the headphone.

15. A cable assembly adapted for use with a personal stereo headphone, the cable assembly comprising:
a plug for plugging into a mobile phone;
a jack for receiving a plug from the headphone;
a control pod having at least one microphone for capturing a voice, an on/off switch for the cable assembly, a volume control for controlling the volume of an audio signal from the mobile phone, and a switch for answering an incoming phone call.

16. The cable assembly of claim 15 wherein the plug for plugging into the mobile phone is a 2.5 mm plug.

17. The cable assembly of claim 16 wherein the jack for receving the plug from the headphone is a 3.5 mm plug.

18. The cable assembly of claim 15 wherein the switch for answering an incoming phone call also is for hanging up on a phone call.

19. The cable assembly of claim 15 wherein the control pod further comprises a switch for hanging up on a phone call.

20. The cable assembly of claim 15 wherein:
the control pod further comprises two microphones for capturing noise and generating a noise signal; and,
the cable assembly further comprises an active noise reduction pod having an active noise reduction circuitry for processing the noise signal and generating a noise canceling signal for delivery to the headphone.

21. A cable assembly adapted for use with a personal stereo headphone, the cable assembly comprising:
a plug for plugging into a mobile phone;
a jack for receiving a plug from the headphone;
at least one microphone for capturing a voice;
an on/off switch for the cable assembly;
a volume control for controlling the volume of an audio signal from the mobile phone; and,
a switch for answering an incoming phone call.

22. A cable assembly adapted for use with a personal stereo headphone, the cable assembly comprising:
a first plug for plugging into a first audio source, the first audio source generating a first audio signal;
a second plug for plugging into a second audio source, the second audio source generating a second audio signal;
a jack for receiving a plug from the headphone;
a control pod having a microphone for capturing a voice, an toggle switch for toggling between the first audio source and the second audio source, a volume control for controlling the volume of the first audio signal and the second audio signal, and a switch for answering an incoming phone call.

23. The cable assembly of claim 22 wherein the first plug is a 2.5 mm plug and the first audio source is a mobile phone.

24. The cable assembly of claim 23 wherein the second plug is a 3.5 mm plug.

25. The cable assembly of claim 24 wherein the second audio source is a music player.

26. The cable assembly of claim 22 wherein the jack for receiving a plug from the headphone is a 3.5 mm jack.

27. The cable assembly of claim 22 wherein the switch for answerin gan incoming phone call is also for hanging up on a phone call.

28. The cable assembly of claim 22 wherein the cable assembly further comprises a third plug for plugging into a third audio source.

29. The cable assembly of claim 22 wherein:
the control pod further comprises two microphones for capturing noise and generating a noise signal; and,
the cable assembly further comprises an active noise reduction pod having an active noise reduction circuitry for processing the noise signal and generating a noise canceling signal for delivery to the headphone.

30. A cable assembly adapted for use with a personal stereo headphone, the cable assembly comprising:
a first plug for plugging into a first audio source, the first audio source generating a first audio signal;
a second plug for plugging into a second audio source, the second audio source generating a second audio signal;
a jack for receiving a plug from the headphone;
a microphone for capturing a voice;
a toggle switch for toggling between the first audio source and the second audio source;
a volume control for controlling the volume of the first audio signal and the second audio signal; and,
a switch for answering an incoming phone call.

31. The cable assembly of claim 30 wherein the cable assembly further comprises two microphones for capturing noise and generating a noise signal and an active noise reduction circuitry for processing the noise signal and generating a noise canceling signal for delivery to the headphone.

32. A cable assembly adapted for use with a personal stereo headphone, the cable assembly comprising:
a first plug for plugging into a first audio source, the first audio source generating a first audio signal;
a second plug for plugging into a second audio source, the second audio source generating a second audio signal;
a jack for receiving a plug from the headphone;
a microphone for capturing a voice;
a toggle switch for toggling between the first audio source and the second audio source;
a volume control for controlling the volume of the first audio signal and the second audio signal;
a switch for answering an incoming phone call;
two microphones for capturing noise and generating a noise signal; and,
an active noise reduction circuitry for processing the noise signal and generating a noise canceling signal for delivery to the headphone.

33. The cable assembly of claim 32 wherein the microphone for capturing a voice and the two microphones for capturing noise are disposed on a microphone pod.

34. The cable assembly of claim 32 wherein the microphone for capturing a voice and the two microphones for capturing noise are housed in a microphone pod.

35. The cable assembly of claim 33 wherein the microphone pod has a clip for attaching to a clothing article of a person.

36. The cable assembly of claim 33 wherein the microphone pod has a strap for attaching to a body of a person.

37. The cable assembly of claim 32 wherein the active noise reduction circuitry is housed in a circuit pod.

38. The cable assembly of claim 33 wherein the microphone pod further houses the toggle switch, the switch for answering an incoming phone call, and the volume control.

39. The cable assembly of claim 32 wherein switch for answering an incoming phone call is a button.

40. A wireless, audio integrating and noise reducing assembly adapted for use with a personal stereo headphone having a wireless receiver, the assembly comprising:
a pod housing housing an active noise reduction circuitry, at least one wireless transmitter for transmitting a first audio signal to the headphone and and a second audio signal to a communications device, and at least one wireless receiver;
a music player having a wireless transmitter for transmitting a first audio signal to the pod;
a communications device having a wireless transmitter for transmitting a second audio signal to the pod;
a microphone for capturing a voice;
a toggle switch for toggling between the first audio source and the second audio source;
a volume control for controlling the volume of the first audio signal to the headphone;
a switch for answering an incoming phone call;
two microphones for capturing noise and generating a noise signal; and,
an active noise reduction circuitry for processing the noise signal and generating a noise canceling signal for delivery to the headphone.

41. A wireless, audio integrating and noise reducing assembly adapted for use with a personal stereo headphone having a wireless receiver, the assembly comprising:
a pod housing housing an active noise reduction circuitry, at least one transceiver for transmitting a first audio signal to the headphone and a second audio signal to a communications device;
a music player having a wireless transmitter for transmitting a first audio signal to the pod;
a communications device having a wireless transmitter for transmitting a second audio signal to the pod;
a microphone for capturing a voice;
a toggle switch for toggling between the first audio source and the second audio source;
a volume control for controlling the volume of the first audio signal to the headphone;
a switch for answering an incoming phone call;
two microphones for capturing noise and generating a noise signal; and,
an active noise reduction circuitry for processing the noise signal and generating a noise canceling signal for delivery to the headphone.

42. The assembly of claim 41 wherein the microphone for capturing a voice and the two microphones for capturing noise and generating a noise signal are housed in a microphone pod.

43. The assembly of claim 43 wherein the microphone pod is connected to the pod by a cable.

44. The assembly of claim 43 wherein the microphone pod is wirelessly connected to the pod.

45. A cable assembly adapted for use with a personal stereo headphone, the cable assembly comprising:
a first plug for plugging into a mobile phone, the mobile phone generating a first audio signal;
a second plug for plugging into an audio source, the audio source generating a second audio signal;
circuitry for delivering either the first audio signal or the second audio signal to the headphone, wherein the circuitry delivers the second audio signal to the headphone by default and the circuitry is adapted to detect an an incoming phone call and automatically switch to delivering the first audio signal to the headphone;
a jack for receiving a plug from the headphone;
a microphone for capturing a voice;
two microphones for capturing noise and generating a noise signal; and,
an active noise reduction circuitry for processing the noise signal and generating a noise canceling signal for delivery to the headphone.
